(19) United States
(12) Patent Application Publication
(10) Pub. No.: US 2012/0181130 A1
(43) Pub. Date: Jul. 19, 2012

(54) TORQUE CONVERTER

(75) Inventor: Takao Fukunaga, Yawata-shi (JP)

(73) Assignee: EXEDY CORPORATION, Neyagawa-shi, Osaka (JP)

(21) Appl. No.: 13/498,219

(22) PCT Filed: Sep. 17, 2010
(86) PCT No.: PCT/JP2010/066204

§ 371 Date: Mar. 26, 2012

(30) Foreign Application Priority Data
Oct. 21, 2009 (JP) 2009-242682

(51) Int. Cl. F16D 33/18

(52) U.S. Cl. 192/3.25

(57) ABSTRACT

It is an object of the present invention to inhibit axial size increase and simplify a structure of a torque converter including a clutch disposed between a front cover and an impeller. The torque converter includes a front cover, a housing, a torque converter main body, a lock-up clutch and an impeller clutch. The housing includes an outer periphery coupled to that of the front cover. The torque converter main body, including an impeller, is disposed in a space enclosed by the front cover and the housing. The impeller clutch is disposed between the housing and the impeller for allowing/preventing torque transmission. Further, the impeller clutch includes a plate fixed to a radially outer part of the impeller and a friction facing disposed between the housing and the plate.

### CROSS-REFERENCE TO RELATED APPLICATIONS

This U.S. national phase application claims priority to Japanese Patent Application No. 2009-242682 filed on Oct. 21, 2009. The entire disclosure of Japanese Patent Application No. 2009-242682 is hereby incorporated herein by reference.

### TECHNICAL FIELD

The present invention relates to a torque converter, particularly to a torque converter including a clutch part disposed between an input-side member and an impeller.

### BACKGROUND ART

The torque converters are devices configured to transmit torque from an engine towards a transmission through operating fluid filled in the inside thereof. The torque converters mainly include a front cover, an impeller and a turbine and a stator. The front cover is an annular member that torque is inputted from the engine. The impeller and the turbine are opposed to each other. Further, a stator is disposed between the inner periphery of the impeller and that of the turbine in order to regulate the flow of the operating fluid flowing from the turbine to the impeller. Further, torque inputted from the front cover into the impeller is transmitted to the turbine from the impeller through the operating fluid, and is then outputted from the turbine towards the transmission.

The torque converters further include a lock-up clutch for enhancing torque transmission efficiency. The lock-up clutch is disposed in a space produced between the turbine and the front cover. The lock-up clutch is configured to directly transmit torque from the front cover to the turbine by mechanically coupling the front cover and the turbine in a region where a function of the torque converter is not required.

Further, a type of torque converters as described in Patent Literature 1 has been produced so far. In the torque converters of this type, a housing is disposed for enclosing a torque converter main body together with a front cover and a clutch is disposed between the housing and an impeller. According to the torque converters of this type, engine load can be reduced and fuel consumption can be saved, for instance, by turning off the clutch when a vehicle is stopped while a shift lever is shifted in a drive range.

### CITATION LIST

### Patent Literature

PTL 1: Japan Laid-open Patent Application Publication No. JP-A-2004-301327

### SUMMARY

### Technical Problems

In the torque converter described in Patent Literature 1, a piston is disposed in a chamber produced between the impeller and the housing, and plural clutch plates are disposed between the piston and the housing. The inner periphery of the piston is engaged with a spline formed on an impeller hub. Therefore, the piston is relatively non-rotatable and axially movable with respect to the impeller.

However, the construction described in Patent Literature 1 has a drawback that the axial size of the torque converter is increased. Specifically, the axially movable piston is required to be disposed between the rear face of the impeller and the housing. Therefore, the housing is bulged towards the transmission. Further, a pump casing is normally disposed between the impeller and the transmission. This further increases the axial size of the torque converter.

Further, the construction described in Patent Literature 1 has another drawback that the torque converter structure is complicated due to sealing members required to be disposed on the inner periphery of the impeller hub and that of the piston.

It is an object of the present invention to inhibit axial size increase and reduce the number of sealing members in a torque converter including a clutch disposed between an input-side member and an impeller.

### Solution to Problems

A torque converter according to a first aspect of the present invention includes a front cover, a housing, a torque converter main body, a lock-up clutch and an impeller clutch. The front cover receives a torque inputted therein from the engine. The housing is opposed to the front cover and includes an outer periphery coupled to an outer periphery of the front cover. The torque converter main body includes an impeller, a turbine and a stator. The torque converter body is disposed in a space enclosed by the front cover and the housing. The lock-up clutch is configured to directly transmit the torque from the front cover to the turbine. The impeller clutch is disposed between the housing and the impeller. The impeller clutch is configured to switch between allowing and preventing transmission of the torque. The impeller clutch includes a plate and a clutch part. The plate is fixed to a radially outer part of the impeller. The clutch part is disposed between the housing and the plate.

In the torque converter, when the impeller clutch is turned on, torque from the engine is inputted into the torque converter main body from the front cover and is outputted from the turbine. When the impeller clutch is turned off, by contrast, torque from the front cover is transmitted to the housing but is not transmitted to the torque converter main body.

Further, when the lock-up clutch is turned on, torque from the front cover is directly transmitted to the turbine through the lock-up clutch.

According to the torque converter of the first aspect of the present invention, the impeller clutch is formed by the plate fixed to the radially outer part of the impeller and the clutch part. The radially outer part of the impeller is normally disposed further away from the transmission than the radially middle part thereof is. In other words, a space is produced between the radially outer part of the impeller and the housing. Therefore, the plate is fixed to the impeller using the space, and the impeller clutch is thus formed. With the structure, it is possible to inhibit axial size increase of the torque converter compared to the well-known torque converters. Further, the plate is fixed to the impeller and the impeller functions as a piston. Therefore, it is not required to provide a sealing member for the piston. In other words, the torque converter can be simply structured.

A torque converter according to a second aspect of the present invention relates to the torque converter according to the first aspect of the present invention. In the torque converter, the clutch part includes a friction member disposed on either the housing or the plate.

According to the torque converter of the second aspect of the present invention, the friction member is disposed between the plate and the housing. The impeller clutch is turned on (i.e., torque transmission allowing state) when the friction member is press-contacted with either of the plate and the housing.

A torque converter according to a third aspect of the present invention relates to the torque converter according to the first aspect of the present invention. In the torque converter, the clutch part includes a first clutch plate and a second clutch plate. The first clutch plate is relatively non-rotatably and axially movably disposed with respect to the housing. The second clutch plate is relatively non-rotatably and axially movably disposed with respect to the plate. Further, the second clutch plate is configured to be press-contacted to the first clutch plate.

According to the torque converter of the third aspect of the present invention, a plurality of friction surfaces can be formed and the torque transmission amount of the impeller clutch can be thereby increased.

A torque converter according to a fourth aspect of the present invention relates to the torque converter according to the second aspect of the present invention. In the torque converter, the lock-up clutch includes a friction member. The friction member of the lock-up clutch has the same size as the friction member of the impeller clutch. According to the torque converter of the forth aspect of the present invention, the friction members can be compatibly used.

A torque converter according to a fifth aspect of the present invention relates to the torque converter according to the first aspect of the present invention. In the torque converter, the impeller clutch is configured to switch between allowing and preventing transmission of the torque between the housing and the impeller including the plate fixed thereto in response to control of a hydraulic pressure in a chamber produced between the impeller and the housing.

### Advantageous Effects of the Invention

As described above, the present invention can inhibit axial size increase of, and simplify the structure of, a torque converter including an impeller clutch.

### BRIEF DESCRIPTION OF THE DRAWINGS

FIG. 1 is a partial cross-sectional view of a torque converter according to an exemplary embodiment of the present invention.

FIG. 2 is a structural cross-sectional view of an impeller clutch according to another exemplary embodiment of the present invention.

### DETAILED DESCRIPTION OF EXEMPLARY EMBODIMENTS

### Entire Structure

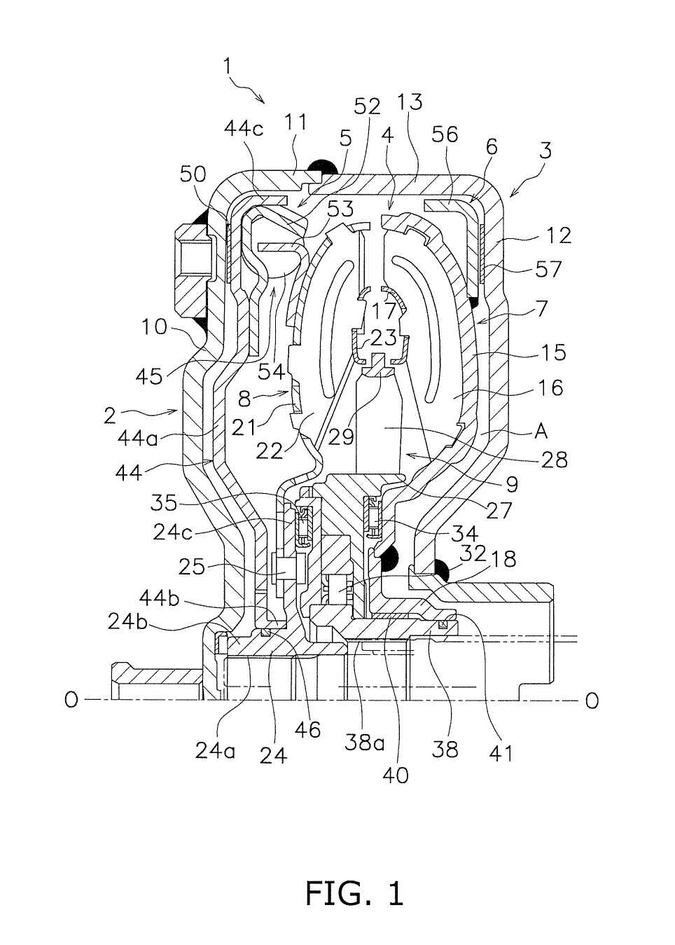

FIG. 1 is a schematic vertical cross-sectional view of a torque converter 1 according to an exemplary embodiment of the present invention . In FIG. 1, a line O-O indicates a rotational center line of the torque converter 1.

The torque converter 1 mainly includes a front cover 2, a housing 3, a torque converter main body 4, a lock-up clutch 5 and an impeller clutch 6. The torque converter main body 4 includes an impeller 7, a turbine 8 and a stator 9.

### Front Cover

The front cover 2 can be attached to a component (not illustrated in the figures) disposed on the engine side (i.e., on the left side in FIG. 1). The front cover 2 receives torque inputted from the engine. The front cover 2 includes a disc portion 10 and a tubular portion 11. The disc portion 10 is positioned on the engine side. The tubular portion 11 is extended from the outer periphery of the disc portion 10 towards the transmission (i.e., rightward in FIG. 1).

### Housing

The housing 3 is opposed to the front cover 2. The housing 3 includes a disc portion 12 and a tubular portion 13. The disc portion 12 is opposed to the disc portion 10 of the front cover 2. The tubular portion 13 is extended from the outer periphery of the disc portion 12 towards the engine. Further, the tip outer periphery of the tubular portion 13 of the housing 3 is fixed to the tip of the tubular portion 11 of the front cover 2 by means of welding.

### Torque Converter Main Body

The torque converter main body 4 is disposed in a space enclosed by the front cover 2 and the housing 3.

The impeller 7, forming a part of the torque converter main body 4, includes an impeller shell 15, a plurality of impeller blades 16 disposed within the impeller shell 15, and an impeller core 17. The impeller 7 further includes an impeller hub 18 fixed to the inner peripheral edge of the impeller shell 15.

The turbine 8 is disposed in an opposed position to the impeller 7. The turbine 8 includes a turbine shell 21, a plurality of turbine blades 22 disposed within the turbine shell 21, and a turbine core 23. The turbine 8 further includes a turbine hub 24 for transmitting torque to the transmission (not illustrated in the figures). The turbine hub 24 includes a tubular portion 24b and a flange 24c. The tubular portion 24b includes a spline hole 24a in the inner periphery thereof. The flange 24c is extended radially outwards from the tubular portion 24b. Further, the inner peripheral edge of the turbine shell 21 is fixed to the flange 24c by means of a plurality of rivets 25.

The stator 9 is configured to regulate the direction of the operating fluid returning from the turbine 8 to the impeller 7. The stator 9 is disposed between the inner periphery of the impeller 7 and that of the turbine 8. The stator 9 includes a stator shell 27, a plurality of stator blades 28 disposed radially outwards of the stator shell 27, and a stator core 29. Further, a one-way clutch 32 is disposed on the inner peripheral side of the stator 9. A first thrust bearing 34 is disposed axially between the stator shell 27 and the impeller shell 15. Further, a second thrust bearing 35 is disposed between the one-way clutch 32 and the flange 24c of the turbine hub 24.

It should be noted that the one-way clutch 32 includes an inner race 38 formed in a tubular shape. The inner race 38 includes a spline hole 38a formed as a part of the inner peripheral surface thereof. The spline hole 38a is fitted onto a stationary shaft. Further, the impeller hub 18 is supported on the outer peripheral surface of the inner race 38 through a bushing 40. Further, a sealing member 41 is disposed on the outer peripheral surface of the end of the inner race 38 for sealing between the impeller hub 18 and the inner race 38.

### Lock-up Clutch

The lock-up clutch 5 is disposed in a space produced between the front cover 2 and the turbine 8. The lock-up clutch 5 mechanically couples the front cover 2 and the turbine 8. The lock-up clutch 5 mainly includes a piston 44 and an elastic coupling mechanism 45 for elastically coupling the piston 44 to the turbine 8.

The piston 44 is a disc-shaped member made of sheet metal. The piston 44 is axially movable and rotatable in a space produced between the front cover 2 and the turbine 8. The piston 44 sections the space produced between the front cover 2 and the turbine 8 into two chambers, i.e., a chamber on the front cover 2 side and a chamber on the turbine 8 side. Further, the piston 44 is configured to be axially moved by means of pressure difference of the operating fluid between the chambers. The piston 44 includes a disc-shaped main body 44a, an inner peripheral side tubular portion 44b and an outer peripheral side tubular portion 44c. The inner peripheral side tubular portion 44b is axially extended from the inner peripheral edge of the main body 44a towards the transmission. The outer peripheral side tubular portion 44c is axially extended from the outer peripheral edge of the main body 44a towards the transmission. The clearance between the outer peripheral surface of the inner peripheral side tubular portion 44b and that of the tubular portion 24b of the turbine hub 24 is sealed by a sealing member 46.

A friction facing 50 is disposed on the engine side of the outer periphery of the main body 44a of the piston 44. The front cover 2 includes a friction surface on a part thereof opposed to the friction facing 50. Torque is configured to be transmitted from the front cover 2 to the piston 44 when the friction facing 50 and the friction surface of the front cover 2 are press-contacted to each other.

The elastic coupling mechanism 45 is disposed between the piston 44 and the turbine 8 for elastically coupling the piston 44 and the turbine 8 in the rotational direction. The elastic coupling mechanism 45 is formed by a retaining plate 52, a driven plate 53 and a plurality of coil springs 54 disposed between the retaining plate 52 and the driven plate 53.

### Impeller Clutch

The impeller clutch 6 is disposed between the housing 3 and the impeller 7. The impeller clutch 6 is configured to switch between allowing and preventing torque transmission between the housing 3 and the impeller 7. The impeller clutch 6 includes a plate 56 and a friction facing 57.

The plate 56 has a disc shape and the outer periphery thereof is bent towards the engine. Further, the inner peripheral edge of the plate 56 is fixed to the housing 3 side surface of the radially outer part of the impeller shell 15 by means of welding. More specifically, the impeller shell 15 has a circular-arc cross-section, as is obvious from FIG. 1. Therefore, a radially middle part of the impeller shell 15 is disposed closest to the disc portion 12. The distance from the impeller shell 15 to the disc portion 12 is gradually increased towards the outer periphery of the impeller shell 15 from the radially middle part thereof. Therefore, a relatively large space is produced between the radially outer part of the impeller shell 15 and the disc portion 12 of the housing 3. In view of this, the plate 56 is fixed to the impeller shell 15 while the inner peripheral edge of the plate 56 is positioned radially outwards of the radially middle part of the impeller shell 15. In short, the impeller clutch 6 is disposed using the space produced between the radially outer part of the impeller shell 15 and the disc portion 12 of the housing 3.

It should be noted that the radially middle part of the impeller shell 15 is generally positioned in the same radial position as the center of a torus formed by the impeller 7, the turbine 8 and the stator 9. Therefore, the plate 56 is only required to be positioned radially outwards of the position.

The friction facing 57 is disposed on the disc portion 12 of the housing 3 while being opposed to the plate 56. Torque is configured to be transmitted from the housing 3 to the impeller 7 when the friction facing 57 is press-contacted to the opposed surface (friction surface) of the plate 56. It should be noted that the size and the material of the friction facing 57 are identical to those of the friction facing 50 of the lock-up clutch 5. Therefore, the friction facing 57 is compatible with the friction facing 50.

### Actions

When torque is transmitted from the engine to the front cover 2 and the housing 3 while the lock-up clutch 5 is turned off (i.e., an uncoupled state) and the impeller clutch 6 is turned on (i.e., a coupled state), the torque is transmitted from the housing 3 to the impeller 7. The impeller 7 is thereby rotated and the operating fluid flows from the impeller 7 to the turbine 8. The turbine 8 is rotated by the flow of the operating fluid. The torque transmitted to the turbine 8 is transmitted to a main drive shaft of the transmission.

It should be noted that a chamber A (see FIG. 1) between the housing 3 and the impeller 7 is drained (i.e., communicated with a tank) when the impeller clutch 6 is turned on. Accordingly, the impeller 7 and the plate 56 fixed thereto are moved towards the housing 3, and the plate 56 is press-contacted to the friction facing 57. Torque from the housing 3 is thereby transmitted to the impeller 7.

When the vehicle is set to be in an idling state, i.e., when the vehicle is stopped while the shift lever is operated in the drive range, the impeller clutch 6 is controlled to be turned off (i.e., the uncoupled state). Specifically, the operating oil is supplied to the chamber A between the housing 3 and the impeller 7. Accordingly, the impeller 7 and the plate 56 are moved away from the housing 3. In other words, press-contact of the plate 56 onto the friction facing 57 is released. Therefore, torque is prevented from being transmitted from the housing 3 to the impeller 7. Engine load is reduced under the condition, and fuel consumption can be thereby saved.

When the travel speed of the vehicle becomes a predetermined speed or greater, the hydraulic pressure is controlled for moving the piston 44 towards the front cover 2 and the lock-up clutch 5 is accordingly turned on. In other words, the friction facing 50 attached to the piston 44 is press-contacted to the friction surface of the front cover 2. In this case, torque inputted into the front cover 2 is directly transmitted to the turbine 8 through the piston 44 and the elastic coupling mechanism 45. The torque transmitted to the turbine 8 is then outputted to the main drive shaft of the transmission.

It should be noted that the impeller clutch 6 can be also used as a system for enhancing dynamic performance when being configured to be turned on in performing a brake operation and be turned off in performing an acceleration operation while the lock-up clutch 5 is turned on.

### Features

The impeller clutch 6 is disposed on the radially outer part of the impeller 7. The impeller 7 and the housing 3 can be thereby disposed closer to each other. In other words, axial size increase of the torque converter can be inhibited.

The impeller clutch 6 is formed by the plate 56 and the friction facing 57, and the plate 56 is fixed to the impeller shell 15 by means of welding. It is thereby possible to cause the impeller shell 15 (the impeller 7) to function as a piston of the impeller clutch 6. In other words, it is not required to additionally provide a piston. Further, it is not required to provide a sealing member required for such a piston to be additionally provided. Thus, the torque converter can be simply structured.

### Other Exemplary Embodiments

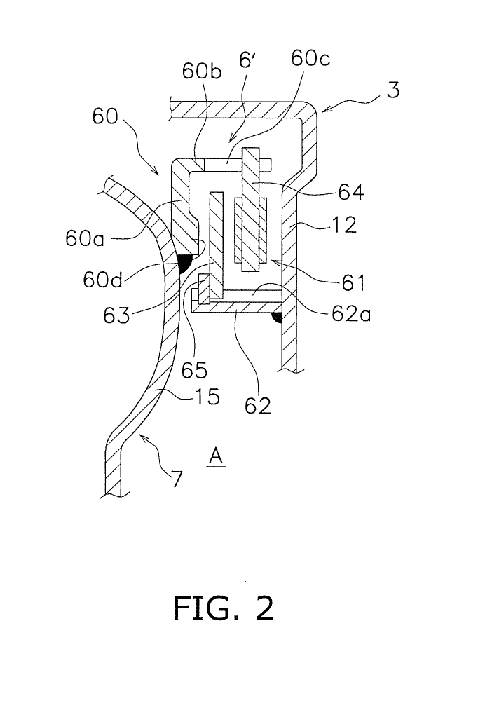

(a) FIG. 2 illustrates an impeller clutch according to another exemplary embodiment. In the present exemplary embodiment, an impeller clutch 6′ includes a plate 60 and a clutch part 61. The plate 60 is fixed to the impeller shell 15 by means of welding. The clutch part 61 is disposed between the plate 60 and the housing 3.

Similarly to the aforementioned exemplary embodiment, the plate 60 is fixed to a radially outer part of the impeller shell 15, and includes a disc-shaped fixation portion 60a and a tubular portion 60b axially extended from the fixation portion 60a towards the transmission. The tubular portion 60b includes a plurality of slits 60c circumferentially aligned thereon at predetermined intervals. The slits 60c are extended from the tip of the tubular portion 60b towards the engine. Further, the fixation portion 60a includes a pressure protrusion 60d on the inner peripheral edge thereof. The pressure protrusion 60d is protruded therefrom towards the housing 3.

The clutch part 61 includes an input-side plate 62 fixed to the disc portion of the housing 3, a first clutch plate 63 and a second clutch plate 64.

The input-side plate 62 has a tubular shape, and one end thereof is fixed to the disc portion 12 of the housing 3 by means of welding. Further, the input-side plate 62 includes a spline 62a on the outer periphery thereof.

The first clutch plate 63 has a disc shape and includes a spline on the inner periphery thereof. The spline of the first clutch plate 63 is engaged with the spline 62a of the input-side plate 62. Accordingly, the first clutch plate 63 is relatively non-rotatable and axially movable with respect to the input-side plate 62. Further, the first clutch plate 63 is disposed in a position where the first clutch plate 63 can be pressed by the pressure protrusion 60d of the plate 60. It should be noted that a snap ring 65 is attached to the engine-side tip of the input-side plate 62. The snap ring 65 prevents the first clutch plate 63 from being detached from the input-side plate 62.

Similarly to the first clutch plate 63, the second clutch plate 64 has a disc shape. The second clutch plate 64 includes a plurality of lugs on the outer periphery thereof. The lugs are engaged with the slits 60c of the plate 60. Accordingly, the second clutch plate 64 is relatively non-rotatable and axially movable with respect to the plate 60. It should be noted that a friction facing is attached to each of the faces of the second clutch plate 64.

In the aforementioned impeller clutch 6′, the first clutch plate 63 is pressed by the pressure protrusion 60d of the plate 60 and is thereby moved towards the housing 3 when the impeller 7 and the plate 60, functioning as a piston, is moved towards the housing 3 in response to reduction in hydraulic pressure in the chamber A. Accordingly, the second clutch plate 64 is interposed and held between the first clutch plate 63 and the disc portion 12 of the housing 3. Therefore, torque inputted into the housing 3 is transmitted to the impeller 7 through the input-side plate 62, the first clutch plate 63, the second clutch plate 64 and the plate 60. In other words, the impeller clutch 6′ is turned on.

When the hydraulic pressure is increased in the chamber A, by contrast, the impeller 7 and the plate 60 are moved away from the housing 3 and press-contact between the first clutch plate 63 and the second clutch plate 64 is released. Accordingly, torque is prevented from being transmitted from the housing 3 to the impeller 7. In other words, the impeller clutch 6′ is turned off.

The present exemplary embodiment can also achieve advantageous effects similar to those achieved by the aforementioned exemplary embodiment. In addition, two friction surfaces are herein formed. Therefore, the torque transmission amount of the impeller clutch can be increased.

(b) In the exemplary embodiment illustrated in FIG. 1, the friction facing is fixed to the disc portion of the housing. However, the friction facing can be attached to the plate.

### INDUSTRIAL APPLICABILITY

According to the torque converter of the present invention, it is possible to inhibit axial size increase thereof, and simultaneously, simplify the construction thereof.

1. A torque converter, comprising:
a front cover receiving a torque inputted therein from an engine;
a housing opposed to the front cover, the housing including an outer periphery coupled to an outer periphery of the front cover;
a torque converter main body including an impeller, a turbine and a stator, the torque converter main body disposed in a space enclosed by the front cover and the housing;
a lock-up clutch configured to directly transmit the torque from the front cover to the turbine; and
an impeller clutch disposed between the housing and the impeller, the impeller clutch configured to allow or prevent transmission of the torque,
wherein the impeller clutch includes: a plate fixed to a radially outer part of the impeller; and a clutch part disposed between the housing and the plate.

2. The torque converter recited in claim 1, wherein the clutch part includes a friction member disposed on either the housing or the plate.

3. The torque converter recited in claim 1, wherein the clutch part includes: a first clutch plate relatively non-rotatably and axially movably disposed with respect to the housing; and a second clutch plate relatively non-rotatably and axially movably disposed with respect to the plate, the second clutch plate configured to be press-contacted to the first clutch plate.

4. The torque converter recited in claim 2,
wherein the lock-up clutch includes a friction member, and
the friction member of the lock-up clutch has the same size as the friction member of the impeller clutch.

5. The torque converter recited in one of claims 1 to 4, wherein the impeller clutch is configured to allow or prevent transmission of the torque between the housing and the impeller including the plate fixed thereto in response to control of a hydraulic pressure in a chamber produced between the impeller and the housing.
